(19) United States
(12) Patent Application Publication
(10) Pub. No.: US 2010/0134592 A1
(43) Pub. Date: Jun. 3, 2010

(54) METHOD AND APPARATUS FOR TRANSCEIVING MULTI-VIEW VIDEO

(76) Inventors: Nac-woo KIM, Seoul (KR); Byung-tak LEE, Gyeonggi-do (KR); Il-kyun PARK, Seoul (KR); Jae-hoon KIM, Jeollanam-do (KR); Seung-hun OH, Gwangju-si (KR); Sang-hyeun LEE, Gwangju-si (KR); Jai-sang KOH, Gwangju-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/512,336

(22) Filed: Jul. 30, 2009

(30) Foreign Application Priority Data
Nov. 28, 2008 (KR) 10-2008-0119672

(51) Int. Cl. H04N 13/00; H04N 11/02; H04N 13/04

(52) U.S. Cl. 348/43; 375/240.26; 348/51; 348/E13.062; 348/E13.075; 348/E13.071; 348/E13.072; 375/E07.026

(57) ABSTRACT

A method and apparatus for transceiving a multi-view video to provide a two-dimensional (2D) video service as well as a three-dimensional (3D) video service or a multi-view 3D video service is provided. When a 2D video or a 3D stereo video or multi-view 3D video is transmitted in a 2D video synthesized by a video synthesizer, format supplementary information about the synthesized video is inserted to the PSI, PES or ES_Descriptor. The synthesized 2D video is decoded by a single video decoder and the decoded synthesized video is recovered to an original video by a video recovery unit with reference to the format supplementary information.

### CROSS-REFERENCE TO RELATED APPLICATION

This application claims the benefit under 35 U.S.C. §119(a) of Korean Patent Application No. 10-2008-0116972, filed on Nov. 28, 2008, the disclosure of which is incorporated by reference in its entirety for all purposes.

### BACKGROUND

1. Field

The following description relates to a video transceiver and, more particularly, to a method and apparatus for transceiving a multi-view video to provide a two-dimensional (2D) video service as well as a three-dimensional (3D) video service or a multi-view 3D video service.

2. Description of the Related Art

A three-dimensional (3D) video technology is essential in the next-generation 3D information terminal technology. As the 3D video technology is expected to have an effect on almost all of the industries, such as broadcasting, entertainment, aerospace, military, medical and movie industries, it is expected to generate a higher value-added business.

The 3D video technology has actively been studied by domestic and foreign research institutes and educational institutions since the stereoscope was first presented by Sir Charles Wheatstone in 1834. A 3D image provides a sense of realism, presence feeling, natural feeling, vividness, etc.

The 3D video technology is classified into stereoscopy and holography. Holography is a technique that allows the light scattered from an object to be recorded and later reconstructed so that it appears as if the object is in the same position relative to the recording medium as it was when recorded. Stereoscopy is a 3D video technique that can be realized with modern technologies and imitates a human visual system to input and output a 3D image from left and right 2D images. Recently, research on a multi-view 3D technology has actively been carried out.

To transmit a 3D stereo video, there is a method of multiplexing left and right videos each of which is assigned packet identifier (PID) on MPEG2-TS. In this case, a typical 2D-based system cannot distinguish the two video streams having the respective PIDs, leading to incompatibility with the 2D-based system.

Alternatively, there is a method of compressing and multiplexing disparity, depth, residual, etc. of left and right videos. This method does not generate incompatibility with the 2D-based system, but cannot transmit a multi-view video. Moreover, it requires an additional decoder to process supplementary information, rather than a typical 2D decoder used in digital broadcasting including an existing IPTV.

### SUMMARY

The following description relates to a method and apparatus for transceiving a multi-view video to provide a two-dimensional (2D) video service as well as a three-dimensional (3D) video service or a multi-view 3D video service using a single video decoder.

In one general aspect, a multi-view video transmitter modulating and transmitting a multiplexed stream includes: a video synthesizer to synthesize a two-dimensional (2D) video, a three-dimensional (3D) stereo video, or a multi-view 3D video into a 2D video format; a format supplementary information generator to generate program specific information (PSI) including formation supplementary information about the synthesized video; a video encoder to encode the 2D synthesized video and to packetize the encoded 2D synthesized video; an audio encoder to encode an audio and packetize the encoded audio; and a multiplexer to multiplex the packet stream and the PSI received from the video encoder and the audio encoder into a signal transport stream.

The format supplementary information may include data indicating a number of views, resolution and video synthesizing format of a 3D video, the data being recorded on a User Private field of the PSI.

In another general aspect, a multi-view video transmitter modulating and transmitting a multiplexed stream includes: a video synthesizer to synthesize a two-dimensional (2D) video, a three-dimensional (3D) stereo video, or a multi-view 3D video into a 2D video format; a format supplementary information generator to generate formation supplementary information about the synthesized video; a video encoder to encode and packetize the 2D synthesized video into which the format supplementary information is incorporated; an audio encoder to encode an audio and packetize the encoded audio; and a multiplexer to multiplex the packet stream received from the video encoder and the audio encoder into a transport stream.

The video encoder may generate packetized elementary stream (PES) information including the format supplementary information, and encode and packetize the 2D synthesized video into which the PES information is incorporated. The video encoder may generate ES_Descriptor information including the format supplementary information, and encode and packetize the 2D synthesized video into which the ES_Descriptor information is incorporated

The format supplementary information may include data indicating a number of views, resolution and video synthesizing format of a 3D video, the data being recorded on a Reserved Data Stream field of Stream ID of the PES information.

The format supplementary information may include data indicating a number of views, resolution and video synthesizing format of a 3D video, the data being recorded on a User Private field of Stream Type of the ES_Descriptor information.

In another general aspect, a multi-view video receiver including a demodulator includes: a demultiplexer to demultiplex a demodulated stream; a video decoder to decode a video transport stream for a 2D synthesized video received from the demultiplexer; an audio decoder to decode an audio transport stream received from the demultiplexer; a format supplementary information extractor to extract format supplementary information about the synthesized video from data received from the demultiplexer or the video decoder; a video recovery unit to receive the format supplementary information and to recover the decoded 2D synthesized video to a 2D video or a 3D stereo video or a multi-view 3D video; and a video/audio output unit to output the recovered video data and the decoded audio data.

The format supplementary information extractor may extract format supplementary information recorded on a User Private field of program specific information (PSI) received from the demultiplexer.

The format supplementary information extractor may extract format supplementary information recorded on a Reserved Data Stream field of Stream ID of packetized elementary stream (PES) information received from the video decoder.

The format supplementary information extractor may extract format supplementary information recorded on a User Private field of Stream Type of ES_Descriptor information received from the video decoder.

However, other features and aspects will be apparent from the following description, the drawings, and the claims.

### BRIEF DESCRIPTION OF THE DRAWINGS

FIG. 1 is a block diagram of a multi-view video transmitter according to an exemplary embodiment of the present invention.

FIG. 2 illustrates a synthesized video in a video synthesizer 100 in FIG. 1.

FIG. 3 is a flow chart of a method of operating a multi-view video transmitter according to an exemplary embodiment of the present invention.

FIG. 4 is a block diagram of a multi-view video receiver according to an exemplary embodiment of the present invention.

FIG. 5 is a flow chart of a method of operating a multi-view video receiver according to an exemplary embodiment of the present invention.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

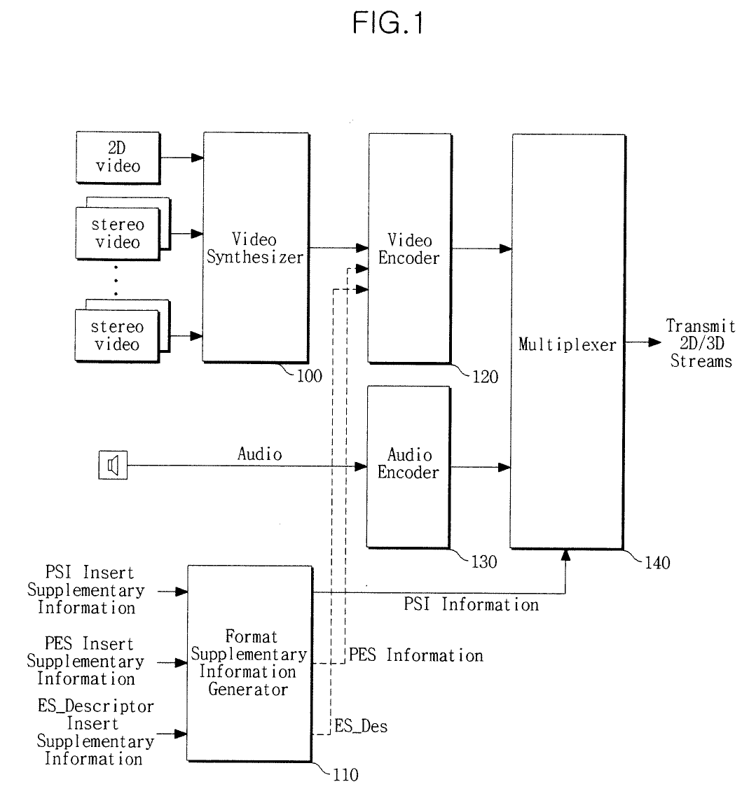

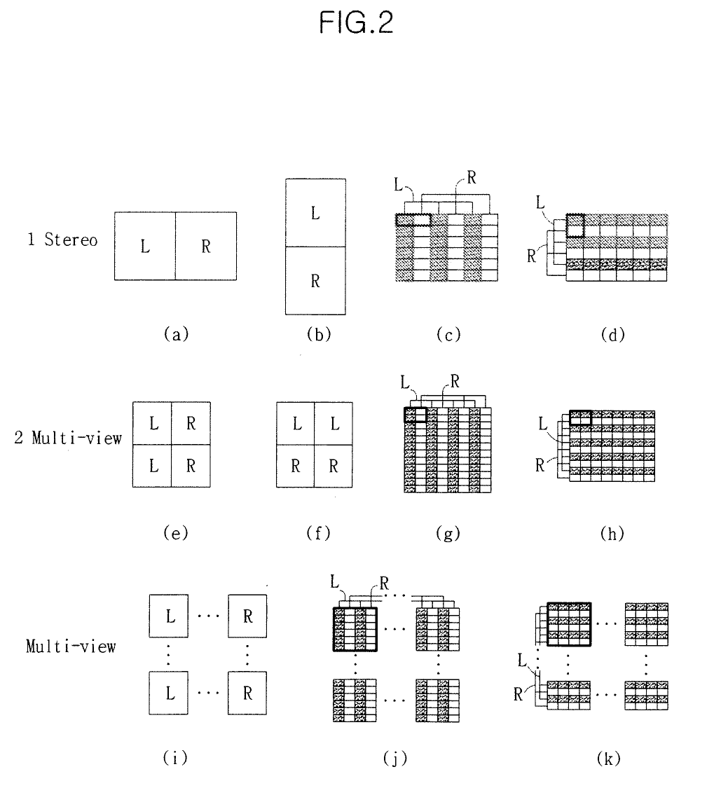

FIG. 1 is a block diagram of a multi-view video transmitter according to an exemplary embodiment of the present invention. FIG. 2 illustrates a synthesized video in a video synthesizer 100 in FIG. 1.

The multi-view video transmitter includes a video synthesizer 100 to synthesize a two-dimensional (2D) video as well as a three-dimensional (3D) stereo video or a multi-view stereo video into a 2D video format.

The video synthesizer 100 synthesizes a 3D stereo video, i.e., left (L)/right (R) videos shown in FIGS. 2(a) and (b), into a 2D video format which is organized in advance as shown in FIGS. 2(c) and (d); a multi-view stereo video, i.e., left (L)/right (R) videos shown in FIGS. 2(e) and (f), into a 2D video format as shown in FIGS. 2(g) and (h); a multi-view stereo video, i.e., left (L)/right (R) videos shown in FIG. 2(i), into a 2D video format as shown in FIGS. 2(j) and (k).

The multi-view video transmitter includes a format supplementary information generator 110 to generate format supplementary information for the synthesized video.

The format supplementary information generator 110 may be implemented in the following three ways.

The first is the case where program specific information (PSI) in an MPEG2-TS format is used. More specifically, the format supplementary information generator 110 generates PSI including format supplementary information about a synthesized video. The format supplementary information includes data on the number of views, resolution and video synthesizing format of a 3D stereo video. The format supplementary information generator 10 records the data on a User Private field of the PSI and outputs it to a multiplexer 140, which will be described below.

The second is the case where packetized elementary stream (PES) information of an MPEG2 video stream is used. In this case, the format supplementary information generator 110 generates format supplementary information about a synthesized video and outputs it to a video encoder 120, which will be described below. The format supplementary information also includes data on the number of views, resolution and video synthesizing format of a 3D stereo video.

The third is the case where a video is encoded using MPEG4/H.264. In this case, the format supplementary information generator 110 generates format supplementary information about a synthesized video and outputs it to the video encoder 120. The format supplementary information also includes data on the number of views, resolution and video synthesizing format of a 3D stereo video.

The multi-view transmitter further includes the video encoder 120 to encode and packetize the 2D video synthesized by the video synthesizer 100. The video encoder 120 may encode and packetize an input video according to MPEG2 or MPEG4/H.264. Accordingly, the video encoder 120 may generate PES information including format 25 supplementary information about the synthesized video generated by the format supplementary information generator 110 and packetize the input video. Alternatively, the video encoder 120 may generate ES_Descriptor information including format supplementary information about the video synthesized by the format supplementary information generator 110 and packetize the input video.

For reference, when the input video is packetized with the PES information, the format supplementary information is recorded on a Reserved Data Stream field of Stream ID of the PES information. On the other hand, when the input video is packetized with the ES_Descriptor information, the format supplementary information is recorded on a User Private field of Stream Type of the ES_Descriptor information.

The multi-view video transmitter further includes an audio encoder 130 and a multiplexer 140. The audio encoder 130 encodes and packetizes audio data. The multiplexer 140 multiplexes packet streams from the encoders 120 and 130 into a transport stream. Although not shown, the multi-view video transmitter may further include a modulator to modulate the multiplexed transport stream, as in a typical multi-view video transmitter.

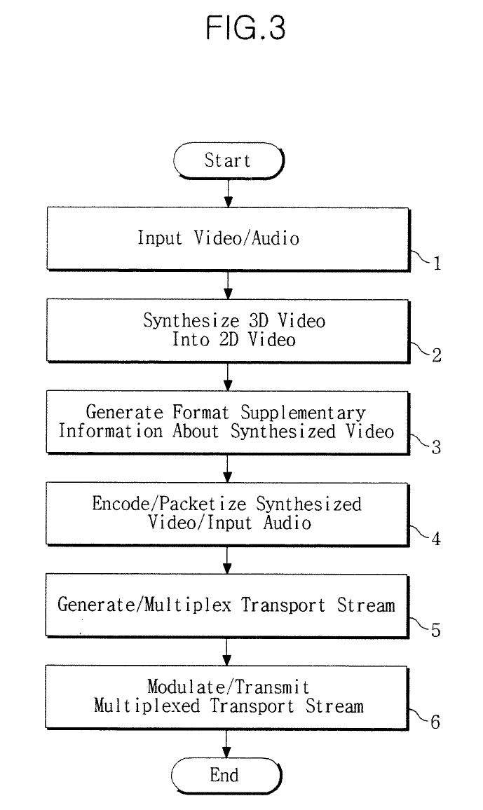

FIG. 3 is a flow chart of a method of operating a multi-view video transmitter according to an exemplary embodiment of the present invention.

In operation 1, the multi-view video transmitter receives a video and an audio. In operation 2, if the video is a 3D stereo video, the video synthesizer 100 synthesizes the 3D stereo video into a 2D video such that left (L) videos and right (R) videos are horizontally alternated as shown in FIG. 2(c), and transmits the 2D video to the video encoder 120.

In operation 3, the format supplementary information generator 110 generates PSI including format supplementary information about the synthesized video and transmits it to the multiplexer 140. The PSI includes data on the number of views, resolution and video synthesizing format of the 3D stereo video. The data is recorded on a User Private field of the PSI as shown in Table 1. Table 1 shows an example of Stream Type of PSI where 0x80˜0xff correspond to the User Private field.

TABLE 1

| Value | Description |
|---|---|
| 0x00 | ITU-T/ISO/IEC Reserved |
| 0x01 | ISO/IEC 11172 Video |
| . . . | . . . |
| 0x80 | Stereo/SD/LR_row |
| 0x81 | Stereo/SD/LR_column |
| 0x82 | Stereo/SD/LR_row_tile |
| 0x83 | Stereo/SD/LR_column_tile |
| 0x84 | Stereo/HD/LR_row |
| . . . | . . . |
| ~0xFF | User Private |

In operation 4, the video encoder 120 encodes and packetizes the synthesized 2D video and the audio encoder 130 also encodes and packetizes the input audio data.

In operation 5, when receiving video and audio packet streams respectively from the video encoder 120 and the audio encoder 130, the multiplexer 140 generates the packet stream and the PSI into a transport stream (TS) and multiplexes the TS. In operation 6, the modulator modulates and transmits the multiplexed TS (3D stream).

In the present embodiment, the format supplementary information is inserted in the PSI on the MPEG2-TS when the multi-view video is transmitted. However, the format supplementary information about the synthesized video may be inserted in PES information when the multi-view video is transmitted.

More specifically, the format supplementary information generator 110 generates and outputs format supplementary information about the synthesized video to the video encoder 120. The video encoder 120 encodes the synthesized video into an elementary stream and packetizes the elementary stream. The video encoder 120 generates PES information including format supplementary information about the synthesized video transmitted from the format supplementary information generator 110. The format supplementary information includes data on the number of views, resolution, and video synthesizing format of a 3D stereo video. The data is recorded on a Reserved Data Stream field of Stream ID of the PES as shown in the following Table 2. Table 2 illustrates Stream ID of revised PES on MPEG 2.

TABLE 2

| common | stream_id | stream_coding |
|---|---|---|
| 0x000001 | | packet_start_code_prefix |
| | Bc | program_stream_map |
| | . . . | . . . |
| | fa | stereoscopic video (1view) |
| | fb | multiview video (2view) |
| | . . . | . . . |
| | ~fe | reserved data stream |
| | Ff | program_stream_directory |

As described above, the video encoder 120 generates and outputs the PES information including the format supplementary information about the synthesized video, and the multiplexer 140 multiplexes and outputs the PES for the video and audio data. The modulator modulates the multiplexed PES and transmits the multi-view video.

Hereinafter, it is assumed that an input video is encoded in MPEG4/H.264. In this case, the video encoder 120 receives format supplementary information about a synthesized video from the format supplementary information generator 110. The video encoder 120 generates ES_Descriptor information including the format supplementary information about the synthesized video and packetizes the input video. In this case, the format supplementary information includes data on at least the number of views, resolution, and video synthesizing format of a 3D stereo video. The data is recorded on a User Private field (0x20˜0x3F) of Stream Type of the ES_Descriptor information as shown in the following Table 3. Table 3 illustrates a Stream Type of revised ES_Descriptor on MPEG4.

TABLE 3

| Stream Type Value | Stream Type Description |
|---|---|
| 0x00 | Reserved for ISO use |
| 0x01 | initialObjectDescriptor |
| . . . | . . . |
| 0x20 | Stereoscopic Video (1view) |
| 0x21 | Multiview Video (2view) |
| . . . | . . . |
| ~0x3F | User Private |

As described above, the video encoder 120 generates the ES_Descriptor information including the format supplementary information about the synthesized video and encodes and packetizes the input video, and the multiplexer 140 multiplexes the stream about the video and audio data and outputs the multiplexed stream. The modulator modulates the multiplexed stream and transmits the multi-view video.

A multi-view video receiver will now be described which recovers the multi-view video transmitted from the multi-view video transmitter.

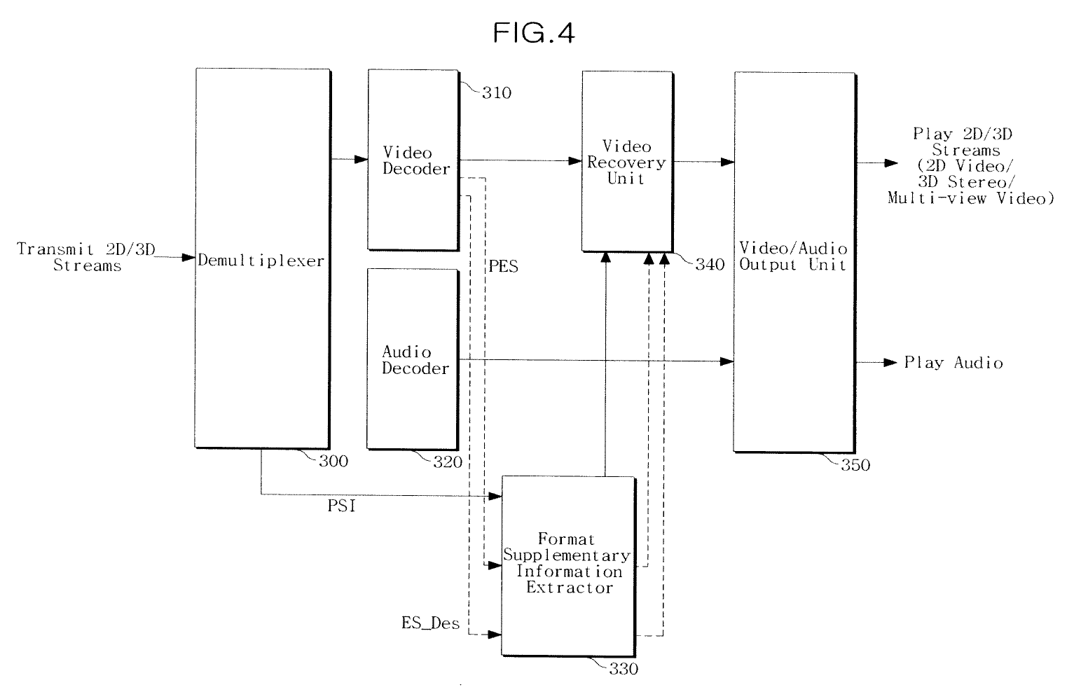

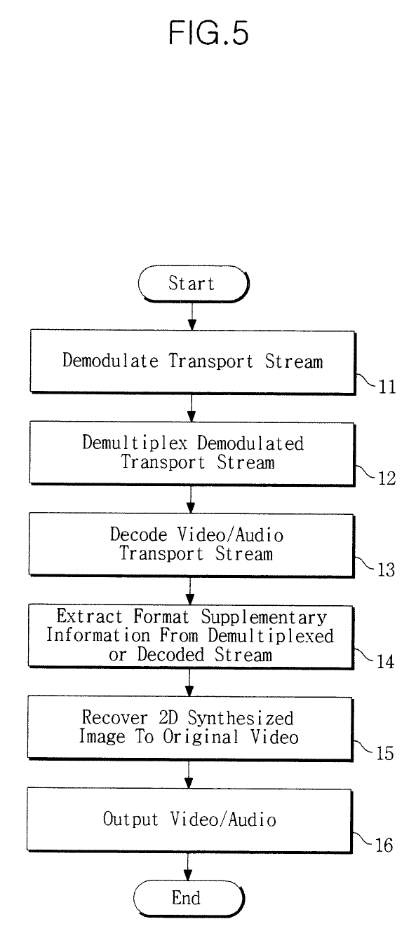

FIG. 4 is a block diagram of a multi-view video receiver according to an exemplary embodiment of the present invention. FIG. 5 is a flow chart of a method of operating a multi-view video receiver according to an exemplary embodiment of the present invention.

Referring to FIG. 4, the multi-view video receiver includes a demultiplexer 300, a video decoder 310, an audio decoder, and a format supplementary information extractor 330. The demultiplexer 300 demultiplexes a multiplexed transport stream. The video decoder is 310 decodes a video transport stream for a 2D synthesized video from the demultiplexer 300. The audio decoder 320 decodes an audio transport stream from the demultiplexer 300. The format supplementary information extractor 330 extracts format supplementary information about the synthesized video from data received from the demultiplexer 300 or the video decoder 310.

For reference, the format supplementary information extractor 330 may extract format supplementary information recorded on a User Private field of the PSI which is received from the demultiplexer 300.

In another embodiment, the format supplementary information extractor 330 extracts format supplementary information recorded on a Reserved Data Stream field of Stream ID of the PES information which is received from the video decoder 310. In another embodiment, the format supplementary information extractor 330 extracts format supplementary information recorded on a User Private field of Stream Type of the ES_Descriptor information which is received from the video decoder 310.

The multi-view video receiver further includes a video recovery unit 340 and a video/audio output unit 350. The video recovery unit 340 recovers a 2D synthesized video, which is received and decoded from the format supplementary information extractor 330, into the 2D video, 3D stereo video or multi-view 3D video. The video/audio output unit 350 outputs the recovered video data and the decoded audio data.

Referring to FIG. 5, in operation 11, the demodulator of the multi-view video receiver demodulates the transport stream (TS) transmitted from the multi-view video transmitter. In operation 12, the demultiplexer 300 demultiplexes the demodulated TS. In operation 13, the video decoder 310 and the audio decoder 320 decodes the demultiplexed video TS and audio TS, respectively.

If the format supplementary information about the synthesized video is included in the PSI, the PSI demultiplexed by the demultiplexer 300 is applied to the format supplementary information extractor 330. In operation 14, the format supplementary information extractor 330 extracts format supplementary information recorded on a User Private field of the PSI and outputs it to the video recovery unit 340.

If the format supplementary information about the synthesized video is included in the PES information, in operation 14, the format supplementary information extractor 330 extracts format supplementary information recorded on a Reserved Data Stream field of Stream ID of the PES information, which is transmitted from the video decoder 310, and outputs it to the video recovery unit 340.

If the format supplementary information about the synthesized video is included in the ES_Descriptor information, in operation 14, the format supplementary information extractor 330 extracts formation supplementary information recorded on the User Private field of Stream Type of the ES_Descriptor information transmitted from the video decoder 310, and transmits it to the video recovery unit 340.

In operation 15, the video recovery unit 340 recovers the 2D synthesized video, which is decoded with reference to the format supplementary information, into a 2D video or 3D stereo video or multi-view 3D video. In operation 16, the recovered video data and the decoded audio data are output from the video/audio output unit 350.

As apparent from the above description, when a 2D video or a 3D stereo video or multi-view 3D video is transmitted in a 2D video synthesized by the video synthesizer, format supplementary information about the synthesized video is inserted to the PSI, PES or ES_Descriptor. The synthesized 2D video is decoded by the video decoder 310 and the decoded synthesized video is recovered to an original video (i.e., 3D stereo video or multi-view 3D video) by the video recovery unit 340 with reference to the format supplementary information.

Accordingly, it is possible to play a multi-view 3D video, for example, in an IPTV equipped with a single video decoder.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-view video transmitter modulating and transmitting a multiplexed stream, comprising:
a video synthesizer to synthesize a two-dimensional (2D) video, a three-dimensional (3D) stereo video, or a multi-view 3D video into a 2D video format;
a format supplementary information generator to generate program specific information (PSI) including formation supplementary information about the synthesized video;
a video encoder to encode the 2D synthesized video and packetize the encoded 2D synthesized video;
an audio encoder to encode an audio and packetize the encoded audio; and
a multiplexer to multiplex the packet stream and the PSI received from the video encoder and the audio encoder into a signal transport stream.

2. The multi-view video transmitter of claim 1, wherein the format supplementary information comprises data indicating a number of views, resolution and video synthesizing format of a 3D video, the data being recorded on a User Private field of the PSI.

3. A multi-view video transmitter modulating and transmitting a multiplexed stream, comprising:
a video synthesizer to synthesize a two-dimensional (2D) video, a three-dimensional (3D) stereo video, or a multi-view 3D video into a 2D video format;
a format supplementary information generator to generate formation supplementary information about the synthesized video;
a video encoder to encode and packetize the 2D synthesized video into which the format supplementary information is incorporated;
an audio encoder to encode an audio and packetize the encoded audio; and
a multiplexer to multiplex the packet stream received from the video encoder and the audio encoder into a transport stream.

4. The multi-view video transmitter of claim 3, wherein the video encoder generates packetized elementary stream (PES) information including the format supplementary information, and encodes and packetizes the 2D synthesized video into which the PES information is incorporated.

5. The multi-view video transmitter of claim 4, wherein the format supplementary information comprises data indicating a number of views, resolution and video synthesizing format of a 3D video, the data being recorded on a Reserved Data Stream field of Stream ID of the PES information.

6. The multi-view video transmitter of claim 3, wherein the video encoder generates ES_Descriptor information including the format supplementary information, and encodes and packetizes the 2D synthesized video into which the ES_Descriptor information is incorporated.

7. The multi-view video transmitter of claim 6, wherein the format supplementary information comprises data indicating a number of views, resolution and video synthesizing format of a 3D video, the data being recorded on a User Private field of Stream Type of the ES_Descriptor information.

8. A multi-view video receiver including a demodulator, comprising:
a demultiplexer to demultiplex a demodulated stream;
a video decoder to decode a video transport stream for a 2D synthesized video received from the demultiplexer;
an audio decoder to decode an audio transport stream received from the demultiplexer;
a format supplementary information extractor to extract format supplementary information about the synthesized video from data received from the demultiplexer or the video decoder;
a video recovery unit to receive the format supplementary information and recover the decoded 2D synthesized video to a 2D video or a 3D stereo video or a multi-view 3D video; and
a video/audio output unit to output the recovered video data and the decoded audio data.

9. The multi-view video receiver of claim 8, wherein the format supplementary information extractor extracts format supplementary information recorded on a User Private field of program specific information (PSI) received from the demultiplexer.

10. The multi-view video receiver of claim 8, wherein the format supplementary information extractor extracts format supplementary information recorded on a Reserved Data Stream field of Stream ID of packetized elementary stream (PES) information received from the video decoder.

11. The multi-view video receiver of claim 8, wherein the format supplementary information extractor extracts format supplementary information recorded on a User Private field of Stream Type of ES_Descriptor information received from the video decoder.

12. A method of transmitting a multi-view video, comprising:
synthesizing a two-dimensional (2D) video, a three-dimensional (3D) stereo video, or a multi-view 3D video into a 2D video format;
creating data including formation supplementary information about the synthesized video;
encoding a 2D synthesized video and an audio and packetizing the encoded 2D synthesized video and audio;
multiplexing the packet stream and the data including format supplementary information into a signal transport stream; and
modulating and transmitting the multiplexed transport stream.

13. The method of claim 12, wherein the data including format supplementary information comprises data indicating a number of views, resolution and video synthesizing format of a 3D video, the data being recorded on a User Private field of program specific information (PSI).

14. A method of transmitting a multi-view video, comprising:
synthesizing a 2D video, a 3D stereo video, or a multi-view 3D video into a 2D video format;
creating formation supplementary information about the synthesized video;
encoding and packetizing the 2D synthesized video into which the format supplementary information is incorporated;
encoding an audio and packetizing the encoded audio;
multiplexing the packet stream into a transport stream; and
modulating and transmitting the multiplexed transport stream.

15. The method of claim 14, wherein the format supplementary information comprises data indicating a number of views, resolution and video synthesizing format of a 3D video, the data being recorded on a Reserved Data Stream field of Stream ID of packetized elementary stream (PES) information.

16. The method of claim 14, wherein the format supplementary information comprises data indicating a number of views, resolution and video synthesizing format of a 3D video, the data being recorded on a User Private field of Stream Type of ES_Descriptor information.

17. A method of receiving a multi-view video, comprising:
demodulating a transport stream (TS);
demultiplexing the demodulated TS;
decoding the demultiplexed video and audio transport streams;
extracting format supplementary information about a synthesized video from the demultiplexed or decoded stream;
recovering a decoded 2D synthesized video to a 2D video or a 3D stereo video or a multi-view 3D video with reference to the extracted format supplementary information; and
outputting the recovered video data and the decoded audio data.

18. The method of claim 17, wherein the format supplementary information comprises data indicating a number of views, resolution and video synthesizing format of a 3D video, the data being recorded on a User Private field of program specific information (PSI).

19. The method of claim 17, wherein the format supplementary information comprises data indicating a number of views, resolution and video synthesizing format of a 3D video, the data being recorded on a Reserved Data Stream field of Stream ID of packetized elementary stream (PES) information.

20. The method of claim 17, wherein the format supplementary information comprises data indicating a number of views, resolution and video synthesizing format of a 3D video, the data being recorded on a User Private field of Stream Type of the ES_Descriptor information.
